(19) United States
(12) Patent Application Publication
(10) Pub. No.: US 2022/0351449 A1
(43) Pub. Date: Nov. 3, 2022

(54) ANIMATION PRODUCTION SYSTEM

(71) Applicants: XVI Inc., Chuo-ku (JP); Avex Technologies Inc., Minato-ku (JP)

(72) Inventors: Yoshihito KONDOH, Chuo-ku (JP); Masato MUROHASHI, Tokyo (JP)

(73) Assignees: XVI Inc., Chuo-ku (JP); Avex Technologies Inc., Minato-ku (JP)

(21) Appl. No.: 16/977,076

(22) PCT Filed: Sep. 24, 2019
(86) PCT No.: PCT/JP2019/037420

§ 371 Date: Aug. 31, 2020

(51) Int. Cl. G06T 13/40; G06T 13/60; G06F 3/01; G02B 27/00; G02B 27/01

(52) U.S. Cl. CPC G06T 13/40; G06T 13/60; G06F 3/012; G02B 27/0093; G02B 27/0179; G02B 27/017; G02B 2027/0138; G02B 2027/014; G02B 2027/0187

(57) ABSTRACT

To enable to shoot animations in a virtual space, an animation production method for providing a virtual space in which a given object is placed, the method comprising: detecting an operation of a user equipped with a head mounted display; controlling the action of the object based on the detected operation of the user; shooting the action of the object; storing an image containing the captured action of the object in a predetermined track; and changing a movement of hair of the object stored in the predetermined track.

### TECHNICAL FIELD

The present invention relates to an animation production system.

### BACKGROUND ART

Virtual cameras are arranged in a virtual space (see Patent Document 1).

### CITATION LIST

### Patent Literature

[PTL 1] Patent Application Publication No. 2017-146651

### SUMMARY OF INVENTION

### Technical Problem

No attempt was made to capture animations in the virtual space.

The present invention has been made in view of such a background, and is intended to provide a technology capable of capturing animations in a virtual space.

### Solution to Problem

The principal invention for solving the above-described problem is an animation production method for providing a virtual space in which a given object is placed, the method comprising: detecting an operation of a user equipped with a head mounted display; controlling the action of the object based on the detected operation of the user; shooting the action of the object; storing an image containing the captured action of the object in a predetermined track; and changing a movement of hair of the object stored in the predetermined track.

The other problems disclosed in the present application and the method for solving them are clarified in the sections and drawings of the embodiments of the invention.

### ADVANTAGEOUS EFFECTS OF INVENTION

According to the present invention, animations can be captured in a virtual space.

### BRIEF DESCRIPTION OF DRAWINGS

FIG. 1 is a diagram illustrating an example of a virtual space displayed on a head mount display (HMD) mounted by a user in an animation production system of the present embodiment;

FIG. 2 is a diagram illustrating an example of the overall configuration of an animation production system 300 according to an embodiment of the present invention.

FIG. 3 shows a schematic view of the appearance of a head mount display (hereinafter referred to as an HMD) 110 according to the present embodiment.

FIG. 4 shows a schematic view of the outside of the controller 210 according to the present embodiment.

FIG. 5 shows a functional configuration diagram of the HMD 110 according to the present embodiment.

FIG. 6 shows a functional configuration diagram of the controller 210 according to the present embodiment.

FIG. 7 shows a functional configuration diagram of an image producing device 310 according to the present embodiment.

FIG. 8 is a flowchart illustrating an example of a track generation and editing process according to an embodiment of the present invention.

FIG. 9 is a diagram illustrating an example of a control screen for adjusting hair movement according to an embodiment of the present invention.

FIG. 10(a) is a diagram illustrating an example of a user interface for editing a track according to an embodiment of the present invention.

FIG. 10(b) is a diagram illustrating an example of a user interface for editing a track according to an embodiment of the present invention.

FIG. 10(c) is a diagram illustrating an example of a user interface for editing a track according to an embodiment of the present invention.

### DESCRIPTION OF EMBODIMENTS

The contents of embodiments of the present invention will be described with reference. An animation production method according to an embodiment of the present invention has the following configuration.

### Item 1

An animation production method for providing a virtual space in which a given object is placed, the method comprising:

detecting an operation of a user equipped with a head mounted display;

controlling the action of the object based on the detected operation of the user;

shooting the action of the object;

storing an image containing the captured action of the object in a predetermined track; and changing a movement of hair of the object stored in the predetermined track.

### Item 2

The method of claim 1 further comprising storing an action parameter for the hair movement of the modified object in the track.

A specific example of an animation production system according to an embodiment of the present invention will be described below with reference to the drawings. It should be noted that the present invention is not limited to these examples, and is intended to include all modifications within the meaning and scope of equivalence with the appended claims, as indicated by the appended claims. In the following description, the same elements are denoted by the same reference numerals in the description of the drawings and overlapping descriptions are omitted.

### Overview

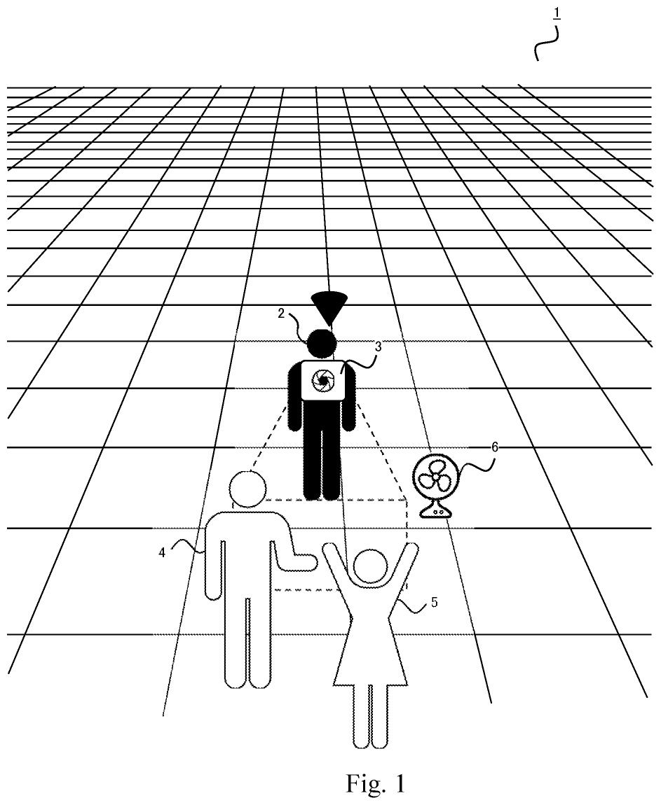

FIG. 1 is a diagram illustrating an example of a virtual space displayed on a head mount display (HMD) mounted by a user in an animation production system of the present embodiment. In the animation production system of the present embodiment, a character 4 and a camera 3 are disposed in the virtual space 1, and a character 4 is shot using the camera 3. In the virtual space 1, the photographer 2 is disposed, and the camera 3 is virtually operated by the photographer 2. In the animation production system of the present embodiment, as shown in FIG. 1, a user makes an animation by placing a character 4 and a camera 3 while viewing the virtual space 1 from a bird's perspective with a TPV (Third Person's View), taking a character 4 with an FPV (First Person View; first person support) as a photographer 2, and performing a character 4 with an FPV. In the virtual space 1, a plurality of characters (in the example shown in FIG. 1, a character 4 and a character 5) can be disposed, and the user can perform the performance while possessing a character 4 and a character 5, respectively. That is, in the animation production system of the present embodiment, one can play a number of roles (roles). In addition, since the camera 2 can be virtually operated as the photographer 2, natural camera work can be realized and the representation of the movie to be shot can be enriched. In addition, the fan 6 in the virtual space can be used to create a style in which the hair and clothes of these characters are danced to the character 4 and the character 5. The fan 6, like the fan in the real world, can have a function such as adjusting the wind direction.

### General Configuration

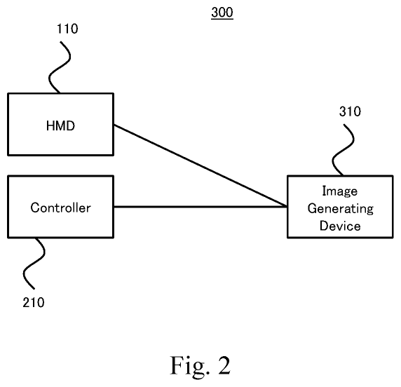

FIG. 2 is a diagram illustrating an example of the overall configuration of an animation production system 300 according to an embodiment of the present invention. The animation production system 300 may comprise, for example, an HMD 110, a controller 210, and an image generating device 310 that functions as a host computer. An infrared camera (not shown) or the like can also be added to the animation production system 300 for detecting the position, orientation and slope of the HMD 110 or controller 210. These devices may be connected to each other by wired or wireless means. For example, each device may be equipped with a USB port to establish communication by cable connection, or communication may be established by wired or wireless, such as HDMI, wired LAN, infrared, Bluetooth (TM), WiFi (TM). The image generating device 310 may be a PC, a game machine, a portable communication terminal, or any other device having a calculation processing function.

### HMD110

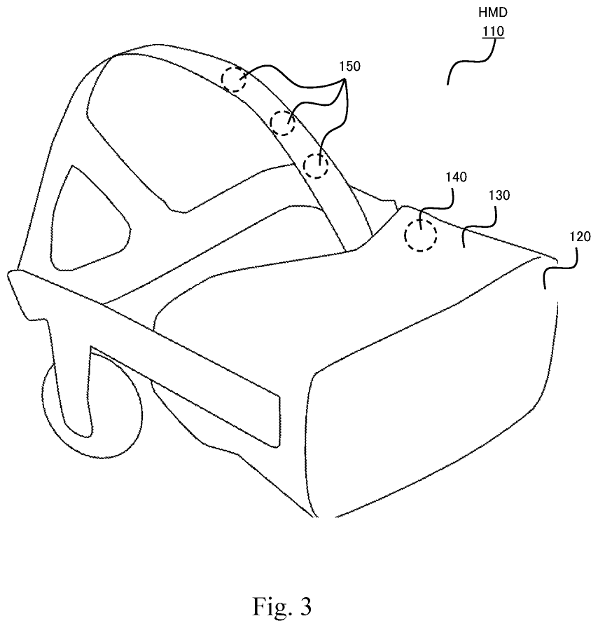

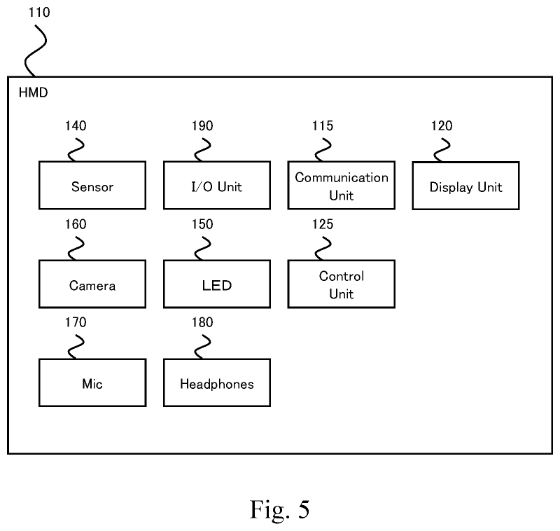

FIG. 3 shows a schematic view of the appearance of a head mount display (hereinafter referred to as HMD) 110 according to the present embodiment. FIG. 5 shows a functional configuration diagram of the HMD 110 according to the present embodiment. The HMD 110 is mounted on the user's head and includes a display panel 120 for placement in front of the user's left and right eyes. Although an optically transmissive and non-transmissive display is contemplated as the display panel, this embodiment illustrates a non-transmissive display panel that can provide more immersion. The display panel 120 displays a left-eye image and a right-eye image, which can provide the user with a three-dimensional image by utilizing the visual difference of both eyes. If left- and right-eye images can be displayed, a left-eye display and a right-eye display can be provided separately, and an integrated display for left-eye and right-eye can be provided.

The housing portion 130 of the HMD 110 includes a sensor 140. The sensor 140 may comprise, for example, a magnetic sensor, an acceleration sensor, or a gyro sensor, or a combination thereof, to detect actions such as the orientation or tilt of the user's head. When the vertical direction of the user's head is Y-axis, the axis corresponding to the user's anteroposterior direction is Z-axis, which connects the center of the display panel 120 with the user, and the axis corresponding to the user's left and right direction is X-axis, the sensor 140 can detect the rotation angle around the X-axis (so-called pitch angle), rotation angle around the Y-axis (so-called yaw angle), and rotation angle around the Z-axis (so-called roll angle).

In place of or in addition to the sensor 140, the housing portion 130 of the HMD 110 may also include a plurality of light sources 150 (e.g., infrared light LEDs, visible light LEDs). A camera (e.g., an infrared light camera, a visible light camera) installed outside the HMD 110 (e.g., indoor, etc.) can detect the position, orientation, and tilt of the HMD 110 in a particular space by detecting these light sources. Alternatively, for the same purpose, the HMD 110 may be provided with a camera for detecting a light source installed in the housing portion 130 of the HMD 110.

The housing portion 130 of the HMD 110 may also include an eye tracking sensor. The eye tracking sensor is used to detect the user's left and right eye gaze directions and gaze. There are various types of eye tracking sensors. For example, the position of reflected light on the cornea, which can be irradiated with infrared light that is weak in the left eye and right eye, is used as a reference point, the position of the pupil relative to the position of reflected light is used to detect the direction of the eye line, and the intersection point in the direction of the eye line in the left eye and right eye is used as a focus point.

### Controller 210

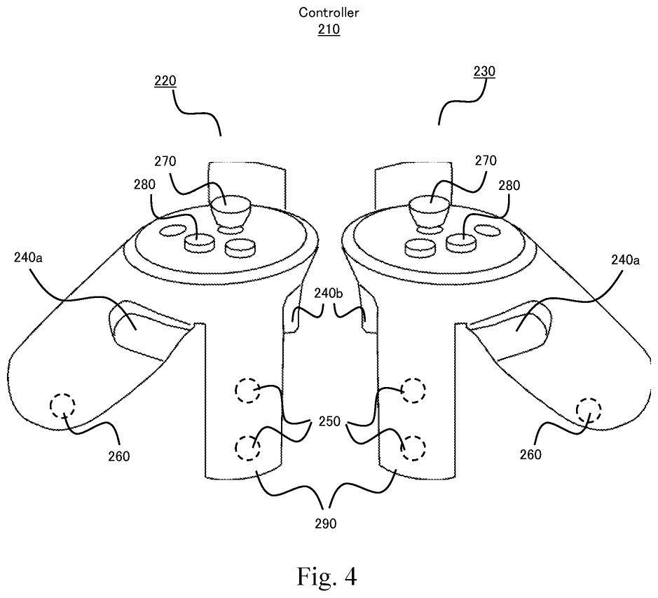

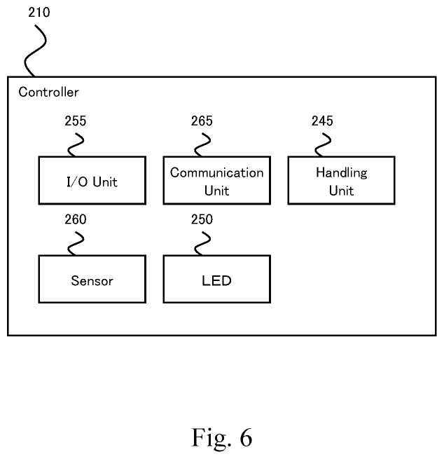

FIG. 4 shows a schematic view of the appearance of the controller 210 according to the present embodiment. FIG. 6 shows a functional configuration diagram of the controller 210 according to the present embodiment. The controller 210 can support the user to make predetermined inputs in the virtual space. The controller 210 may be configured as a set of left-hand 220 and right-hand 230 controllers. The left hand controller 220 and the right hand controller 230 may each have an operational trigger button 240, an infrared LED 250, a sensor 260, a joystick 270, and a menu button 280.

The operation trigger button 240 is positioned as 240a, 240b in a position that is intended to perform an operation to pull the trigger with the middle finger and index finger when gripping the grip 235 of the controller 210. The frame 245 formed in a ring-like fashion downward from both sides of the controller 210 is provided with a plurality of infrared LEDs 250, and a camera (not shown) provided outside the controller can detect the position, orientation and slope of the controller 210 in a particular space by detecting the position of these infrared LEDs.

The controller 210 may also incorporate a sensor 260 to detect operations such as the orientation or tilt of the controller 210. As sensor 260, it may comprise, for example, a magnetic sensor, an acceleration sensor, or a gyro sensor, or a combination thereof. Additionally, the top surface of the controller 210 may include a joystick 270 and a menu button 280. It is envisioned that the joystick 270 may be moved in a 360 degree direction centered on the reference point and operated with a thumb when gripping the grip 235 of the controller 210. Menu buttons 280 are also assumed to be operated with the thumb. In addition, the controller 210 may include a vibrator (not shown) for providing vibration to the hand of the user operating the controller 210. The controller 210 includes an input/output unit and a communication unit for outputting information such as the position, orientation, and slope of the controller 210 via a button or a joystick, and for receiving information from the host computer.

With or without the user grasping the controller 210 and manipulating the various buttons and joysticks, and with information detected by the infrared LEDs and sensors, the system can determine the user's hand operation and attitude, pseudo-displaying and operating the user's hand in the virtual space.

### Image Generator 310

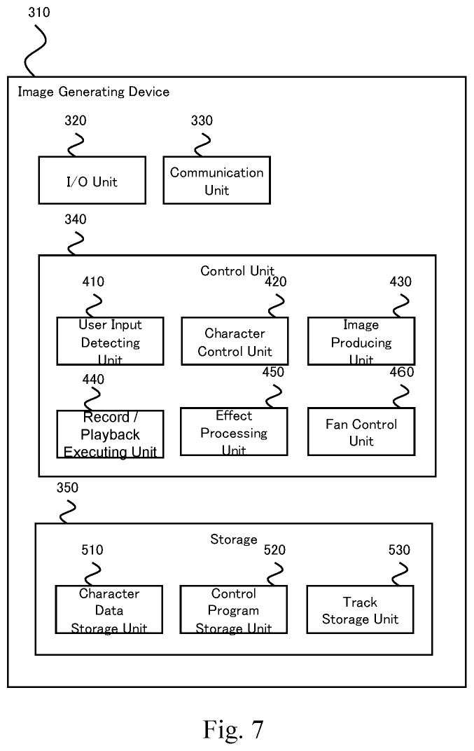

FIG. 7 shows a functional configuration diagram of an image producing device 310 according to this embodiment. The image producing device 310 may use a device such as a PC, a game machine, or a portable communication terminal having a function for storing information on the user's head operation or the operation or operation of the controller acquired by the user input information or the sensor, which is transmitted from the HMD 110 or the controller 210, performing a predetermined computational processing, and generating an image. The image producing device 310 may include an input/output unit 320 for establishing a wired connection with a peripheral device such as, for example, an HMD 110 or a controller 210, and a communication unit 330 for establishing a wireless connection such as infrared, Bluetooth, or WiFi (registered trademark). The information received from the HMD 110 and/or the controller 210 regarding the operation of the user's head or the operation or operation of the controller is detected in the control unit 340 as input content including the operation of the user's position, line of sight, attitude, speech, operation, etc., through the I/O unit 320 and/or the communication unit 330. The control unit 350 executes a control program stored in the storage unit 350 according to the user's input content, and performs a process such as controlling the character and generating an image. The control unit 340 may be composed of a CPU. However, by further providing a GPU specialized for image processing, information processing and image processing can be distributed and overall processing efficiency can be improved. The image generating device 310 may also communicate with other computing processing devices to allow other computing processing devices to share information processing and image processing.

The control unit 340 includes a user input detecting unit 410 that detects information received from the HMD 110 and/or the controller 210 regarding the operation of the user's head, speech of the user, and operation of the controller, a character control unit 420 that executes a control program stored in the control program storage unit for a character stored in the character data storage unit 440 of the storage unit 350 in advance, and an image producing unit 430 that generates an image based on character control. Here, the control of the operation of the character is realized by converting information such as the direction, inclination, or manual operation of the user head detected through the HMD 110 or the controller 210 into the operation of each part of the bone structure created in accordance with the movement or restriction of the joints of the human body, and applying the operation of the bone structure to the previously stored character data by relating the bone structure. Further, the control unit 340 includes a record/playback executing unit 440 for recording and playing back an image-generated character on a track, and an editing executing unit 450 for editing each track and generating the final content. The control unit 340 includes a fan control unit 460 for controlling the placement position, air flow rate, and wind direction of the fan 6 in the virtual space 1.

The storage unit 350 includes a character data storage unit 510 for storing not only image data of a character but also information related to a character such as attributes of a character. The control program storage unit 520 stores a program for controlling the operation of a character or an expression in the virtual space. The storage unit 350 includes a track storage unit 530 for storing action data composed of parameters for controlling the movement of the character (including the movement of the paper) in the moving image generated by the image producing unit 630.

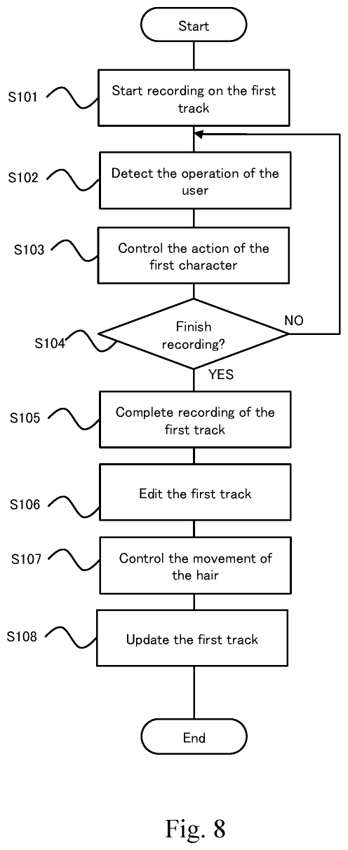

FIG. 8 is a flowchart illustrating an example of a track generation and editing process according to an embodiment of the present invention.

First, the record/playback executing unit 440 of the control unit 340 of the image producing device 310 starts recording for storing action data of the moving image related to operation by the first character in the virtual space in the first track of the track storage unit 530 (S101). Here, the position of the camera where the character is to be shot and the viewpoint of the camera (e.g., FPV, TPV, etc.) can be set. For example, in the virtual space 1 illustrated in FIG. 1, the position where the camera man 2 is disposed and the angle of the camera 3 can be set with respect to the character 4 corresponding to the first character. The recording start operation may be indicated by a remote controller, such as controller 210, or may be indicated by other terminals. The operation may also be performed by a user who is equipped with an HMD 110 to manipulate the controller 210, to play a character, or by a user other than the user who performs the character. In addition, the recording process may be automatically started based on detecting an operation by a user who performs the character described below.

Subsequently, the user input detecting unit 410 of the control unit 340 detects information received from the HMD 110 and/or the controller 210 regarding the operation of the user's head, speech of the user, and operation or operation of the controller (S102). For example, when the user mounting the HMD 110 tilts the head, the sensor 140 provided in the HMD 110 detects the tilt and transmits information about the tilt to the image generating device 310. The image generating device 310 receives information about the operation of the user through the communication unit 330, and the user input detecting unit 410 detects the operation of the user's head based on the received information. Also, when a user performs a predetermined operation or operation, such as lifting the controller 210 or pressing a button, the sensor 260 provided in the controller detects the operation and/or operation and transmits information about the operation and/or operation to the image generating device 310 using the controller 210. The image producing device 310 receives information related to the user's controller operation and operation through the communication unit 330, and the user input detecting unit 410 detects the user's controller operation and operation based on the received information.

Subsequently, the character control unit 420 of the control unit 340 controls the operation of the first character in the virtual space based on the operation of the detected user (S103). For example, based on the user detecting an operation to tilt the head, the character control unit 420 controls to tilt the head of the first character. Also, based on the fact that the user lifts the controller and detects pressing a predetermined button on the controller, the character control unit 420 controls to grasp something while extending the arm of the first character upward. In this manner, the character control unit 420 controls the first character to perform the corresponding operation each time the user input detecting unit 410 detects an operation by a user transmitted from the HMD 110 or the controller 210. Stores parameters related to the operation and/or operation detected by the user input detecting unit 410 in the first track of the track storage unit 530. Alternatively, the character may be controlled to perform a predetermined performance action without user input, the action data relating to the predetermined performance action may be stored in the first track, or both user action and action data relating to the predetermined behavior may be stored.

Subsequently, the record/playback executing unit 440 confirms whether or not the user receives the instruction to end the recording (S104), and when receiving the instruction to end the recording, completes the recording of the first track related to the first character (S105). The record/playback executing unit 440 continues the recording process unless the user receives an instruction to end the recording. Here, the record/playback executing unit 440 may perform the process of automatically completing the recording when the operation by the user acting as a character is no longer detected. It is also possible to execute the recording termination process at a predetermined time by activating a timer rather than accepting instructions from the user.

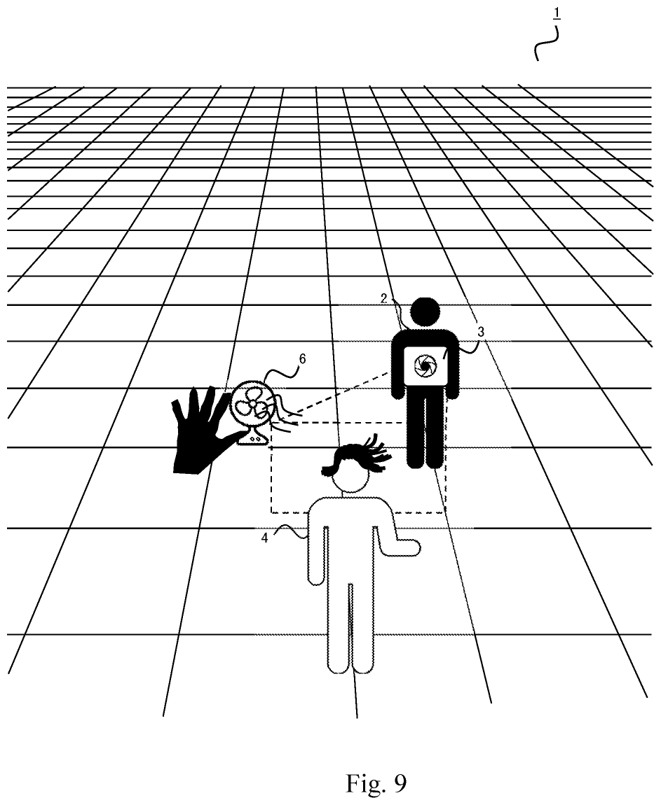

Subsequently, the editing execution unit 450 edits the first track stored in the track storage unit 530 (S106). For example, the user edits a first track (T1) associated with the first character via a user interface for track editing, as shown in FIG. 9(a). For example, the user interface displays the area in which the first track is stored along a time series. A user selects a desired bar to play back a moving image of a character (e.g., a character 4) disposed in the virtual space as shown in FIG. 1. It should be noted that as a user interface for editing tracks, it is also possible to display, for example, a track name and title (e.g., a “first character”) in a list format, in addition to the display described above.

Subsequently, in order to control the movement of the hair of the first character stored in the first track, the fan control unit 460 controls the flow amount and the wind direction of the fan (S107). As a method for adjusting the movement of the hair of a character, the user input detecting unit 410 of the control unit 310 detects an operation signal by a user, such as pushing down an operation button of the controller 420, and the fan control unit 460 arranges the fan 6 in a virtual space 1 on the control screen as shown in FIG. 9 at a position opposite to the character 4 to adjust the air flow rate and the wind direction of the fan. The character control unit 420 controls the movement so that the wind generated by the fan 6 includes the direction of the hair of the character 4 in response to the character 4. Here, by adjusting the position of the fan, the object for controlling the movement can be a desired part of the character, such as the clothing of the character, an accessory, or an object (letter) held in the hand. In addition, by installing a plurality of fans in the virtual space, it is possible to adjust the strength, weakness, and direction of the movement caused by the wind in the same character, such as weakening the movement of the clothes, while strengthening the movement of the hair.

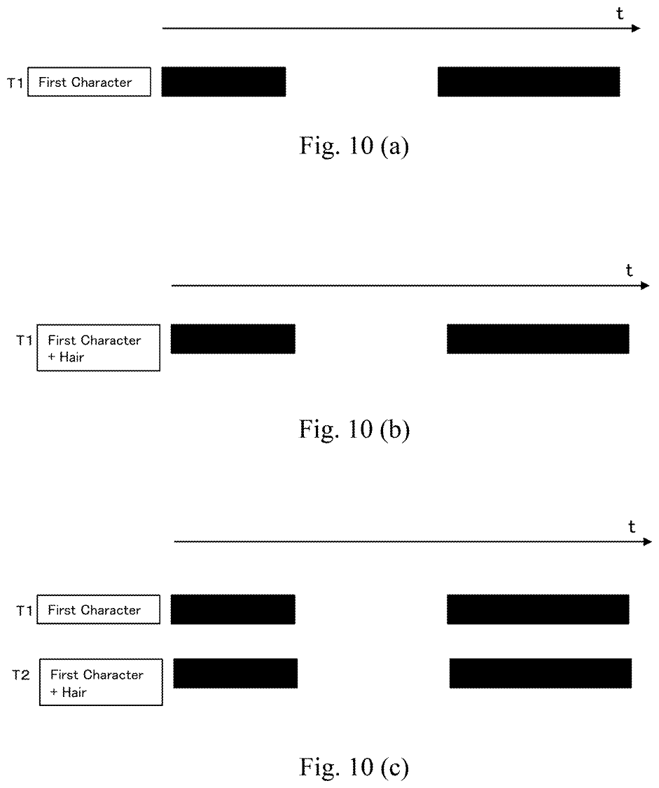

Subsequently, the editing execution unit 450 performs the process of updating the first track according to a user's request or by automatically storing the edited contents (S108). Here, as shown in FIG. 10B, in addition to the form of overwriting the action parameters relating to the movement of the hair of the character updated in the first track as the action data, as shown in FIG. 9c, the original track (T1) can be newly created while leaving another track (T2) and the action data relating to the movement of the hair of the updated character can be stored in the generated track (T2) together with the action data relating to the movement of the hair of the updated character. This allows the user to more flexibly edit each track.

As described above, by applying the method of multitrack recording (MTR) to the animation production according to the present embodiment, a character operation linked to the user operation can be stored in a track, and an update processing of the movement of the hair of the character can be performed for a character stored in a track, thereby realizing simple and efficient animation production.

Although the present embodiment has been described above, the above-described embodiment is intended to facilitate the understanding of the present invention and is not intended to be a limiting interpretation of the present invention. The present invention may be modified and improved without departing from the spirit thereof, and the present invention also includes its equivalent.

For example, in this embodiment, while a character has been described as an example with respect to a track generation method and an editing method, the method disclosed in this embodiment may be applied to an object (vehicle, structure, article, etc.) comprising an action, including not only a character, but also a character.

For example, although the image producing device 310 has been described in this embodiment as separate from the HMD 110, the HMD 110 may include all or part of the configuration and functions provided by the image producing device 310.

### EXPLANATION OF SYMBOLS

1 virtual space

2 cameraman

3 cameras

4 characters

5 characters

110 HMD

210 controller

310 Image Generator

1. An animation production method for providing a virtual space in which a given object is placed, the method comprising:
detecting an operation of a user equipped with a head mounted display;
controlling the action of the object based on the detected operation of the user;
shooting the action of the object;
storing an image containing the captured action of the object in a predetermined track; and
changing a movement of hair of the object stored in the predetermined track.

2. The method of claim 1 further comprising storing an action parameter for the hair movement of the modified object in the track.
